(19) United States
(12) Patent Application Publication
(10) Pub. No.: US 2012/0069397 A1
(43) Pub. Date: Mar. 22, 2012

(54) TRANSPONDER WITH MEMORY FOR INK JET MEDIA

(76) Inventor: Michael R. Bury, White Bear Lake, MN (US)

(21) Appl. No.: 13/232,413

(22) Filed: Sep. 14, 2011

Related U.S. Application Data
(60) Provisional application No. 61/383,864, filed on Sep. 17, 2010.

(51) Int. Cl. G06F 3/12

(52) U.S. Cl. 358/1.15

(57) ABSTRACT

A method for printing a medical image transmits, from a transceiver that is associated with a printer, a wireless query signal and receives a wireless response signal from a transponder that is coupled to a print medium, the transponder having a memory, wherein the response signal is indicative of at least a media orientation and type available for printing. Image data and image orientation information associated with the image data are obtained and a prompt signal provided that indicates a discrepancy between the media orientation and the image orientation associated with the image data. In response to an operator instruction, printing continues.

### REFERENCE TO RELATED APPLICATIONS

This application claims priority to U.S. Provisional Patent Application Ser. No. 61/383,864 filed Sep. 17, 2010 to Bury entitled RFID FOR INK JET PRINTERS, incorporated herein by reference in its entirety.

### FIELD OF THE INVENTION

The invention relates to the field of medical imaging and more particularly relates to methods and apparatus that provide information on consumable media and more closely correlate print output with diagnostic image data.

### BACKGROUND OF THE INVENTION

With continuing advancements in medical imaging technologies, there is a need for improved performance of print devices that provide the image content in hard copy form. The need for more accurate assessment and diagnosis of image content drives the need for increased resolution, more accurate color, broader dynamic range, and higher overall image quality. In response to this need, various types of printing devices have been adapted, including laser printers and ink jet printers.

In an ink jet recording or printing system, ink is ejected from a nozzle onto a recording film, element, or medium, to produce an image. The ink, or recording liquid, can comprise one or more recording agents, such as a dye or pigment. The ink can also comprise one or more solvents, or carrier liquids, such as water or organic compounds, such as, for example, monohydric alcohols or polyhydric alcohols. The recording film, element or sheet medium can have any of a range of characteristics including color, texture, size, smoothness, opacity, and type, for example. One or more of these characteristics can have noticeable effect on image quality and the overall suitability of the obtained image for clinical or diagnostic use. Recent developments in ink jet technology have shown that very high levels of image quality can be achieved reliably and repeatedly, making ink jet technology a promising candidate for medical diagnostic imaging applications.

The well-known DICOM (Digital Imaging and Communications in Medicine) standard has been widely adapted to help with the storage and management of huge databases of medical images. DICOM provides standardized formats for images, a common information model, application service definitions, and a protocol for communication. DICOM is based upon the Open System Interconnect (OSI) reference model, which defines a seven-layer protocol. In the OSI context, DICOM is an “application level” standard, i.e., DICOM is implemented in the seventh or uppermost layer. This layer supports application and end-user processes. Communication partners are identified, quality of service is identified, user authentication and privacy are considered, and any constraints on data syntax are identified. The data handling that is performed in this layer is application-specific.

Within the DICOM standard, a significant amount of metadata can be stored for each individual medical image. This metadata can include patient attributes; practitioner identification and information; information about the image itself, such as date, time, type of imaging system used, exam type, and equipment settings utilized to obtain the image; image size, resolution, imaging characteristics, and other related data. Each attribute has a name, a value representation and a tag. A tag is a number unique to the attribute, e.g., (0040,0100), and is used to identify the attribute. A value representation defines what type of variable can represent a particular attribute (e.g., a 64-character string, binary data, etc.).

The high value of the diagnostic information that is contained in medical images and the need for suitable image quality place high demands on ink jet printer performance. An ink jet printer used for medical imaging applications must not only meet exacting standards for image quality, but must also be able to adapt appropriately to image content from a range of different types of imaging apparatus, including ultrasound, x-ray, and other imaging apparatus. Images can be stored in an image database, such as the DICOM standard supports, or provided directly from any of a number of types of imaging systems. Various types of imaging media can be used, depending on the image type, including paper or other opaque sheet media as well as film that is used for backlit display. With some systems, imaging inks may be of different types, may be interchangeable, and may have different characteristics.

Because of the large number of variables involved and the need for superior image quality, it can be appreciated that there is a significant need for obtaining useful information related to the type of image that is to be printed and to characteristics of the print consumables that will be used.

### SUMMARY OF THE INVENTION

Embodiments of the present invention are directed to improving the printing of medical images from an ink jet printer. Encoded information stored with the print media is used to help determine printer setup and operation to provide high quality output prints for use in clinical and diagnostic applications. This enables different types of print media to be used on the same printing device, allowing the printer to adapt the image content and output parameters appropriately for the end-user, and appropriately for the media that is used.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for printing a medical image, the method comprising: transmitting, from a transceiver that is associated with a printer, a wireless query signal; receiving a wireless response signal from a transponder that is coupled to a print medium, the transponder having a memory, wherein the response signal is indicative of at least a media orientation and type available for printing, obtained from the memory; obtaining image data and image orientation information associated with the image data; providing a prompt signal that indicates a discrepancy between the media orientation and the image orientation associated with the image data; and responding to an operator instruction to continue printing.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic block diagram that shows the configuration of a printer within a network providing medical images.

FIG. 2 is a side view of a printer that is adapted to sense media type and orientation according to an embodiment of the present invention.

FIG. 3A is a top view of a printer adapted to sense media type and orientation, showing the media in a landscape print orientation.

FIG. 3B is a top view of a printer adapted to sense media type and orientation, showing the media in a portrait print orientation.

FIG. 4 is a schematic block diagram showing components of an RFID transponder according to an embodiment of the present invention.

FIG. 5 is a schematic block diagram showing an ink jet printer application for generating medical images.

FIG. 6A is a logic flow diagram that shows a sequence of signals and responses for printing an image according to an embodiment of the present invention.

FIG. 6B is a logic flow diagram showing steps for a print application using an embodiment of the present invention.

FIG. 7 is a plan view of an exemplary operator prompt for obtaining a response to a detected discrepancy for loaded media.

### DETAILED DESCRIPTION OF THE INVENTION

The following is a detailed description of the preferred embodiments of the invention, reference being made to the drawings in which the same reference numerals identify the same elements of structure in each of the several figures.

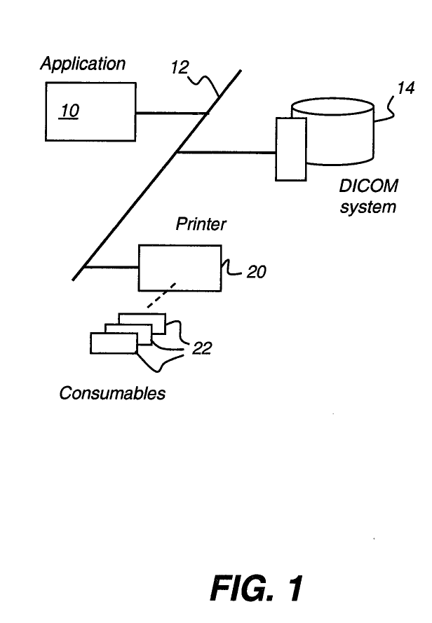

The schematic block diagram of FIG. 1 shows a printer 20 that is configured, through communication over a network 12, to print diagnostic images from a database 14, such as a DICOM or other medical image database system, or from an application 10, such as directly from an imaging apparatus. Network 12 can be any of a number of different network arrangements and includes connection of printer 20 through a networked computer or host processor, for example. A number of consumables 22 are provided for printer 20, including ink and paper or film media for an ink jet printer, for example.

In embodiments of the present invention, printer 20 has a given media configuration with variable parameters that may include media orientation as well as type of medium, such as film or paper, for example. This configuration for the media that is currently installed is compared against the incoming image data in order to adapt printer behavior appropriately for media conditions. To help identify the currently installed media type and configuration, an electronic memory is coupled to the media and, alternately, to other printer consumables 22. According to an embodiment of the present invention, the electronic memory is in the form of an RFID transponder, also termed an RFID tag, allowing wireless communication between the transponder and an interrogating transponder.

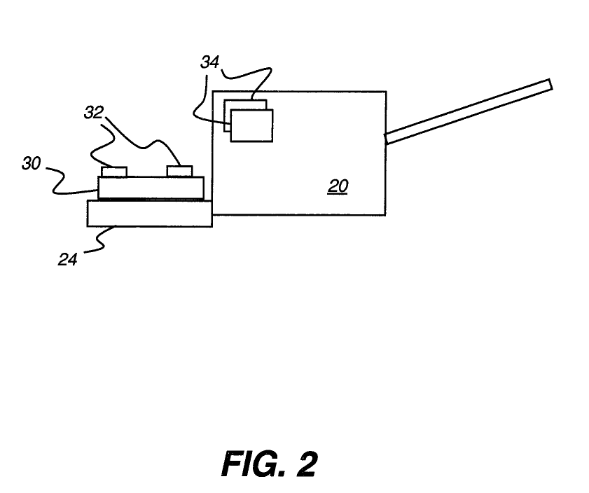

FIG. 2 is a side view of printer 20 according to an embodiment of the present invention. A media feed mechanism 24 supports a media package 30 for providing print media to printer 20. In the embodiment shown in FIG. 2, media package 30 is shown as a type of cassette. In practice, media package 30 can be such a holder of single sheets or may alternately be a roll of print media, or media that is packaged in some other suitable format, for example. One or more RFID tags 32 are coupled to media package 30, such as mounted to the cassette or roll, for example. To communicate with RFID tags 32, one or more transponders 34 is provided as part of printer 20.

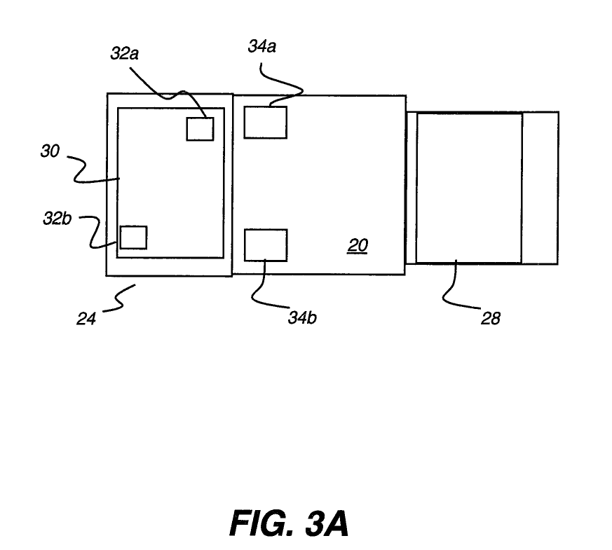

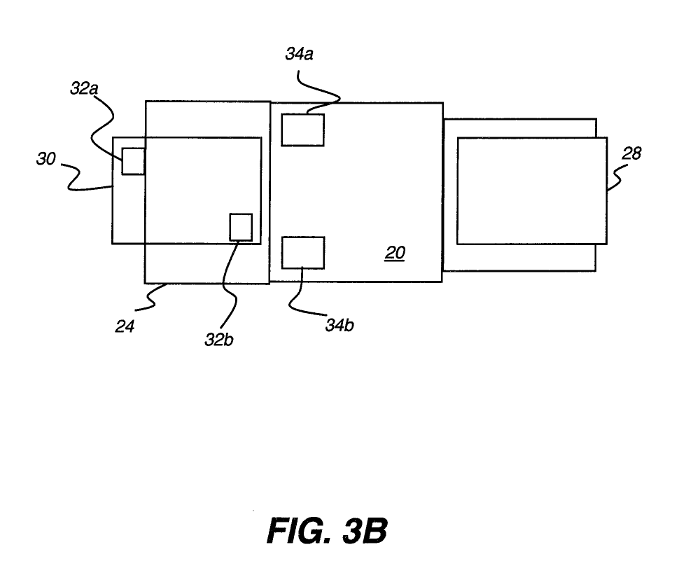

FIG. 3A shows a top view of printer 20 and media support components, with media package 30 in a landscape orientation. FIG. 3B shows a top view of printer 20 and media support components, with media package 30 in an alternate portrait orientation, rotated 90 degrees from that shown in FIG. 3A.

Media orientation, while it can be relatively unimportant for many standard printer types, is of particular interest for printing many types of medical images. A DICOM data field identifies image orientation and is stored as metadata related to the stored image. The arrangement using two RFID tags 32a and 32b, spaced apart at different respective positions on media package 30 as shown in FIGS. 3A and 3B, enables printer 20 to quickly determine the orientation of the media, whether landscape as in FIG. 3A or portrait as in FIG. 3B. Signal strength relative to transponder position is used in one embodiment of the present invention. In the FIG. 3A configuration, for example, transceiver 34a detects a signal from RFID tag 32a at a higher signal strength than a signal from RFID tag 32b. In the FIG. 3B configuration, on the other hand, transceiver 34b detects a signal from RFID tag 32b at a higher signal strength than from RFID tag 32a. It can be appreciated that indicators other than signal strength can be used, such as encoded information, for example. A single transceiver and a single RFID transponder could alternately be used to determine media orientation.

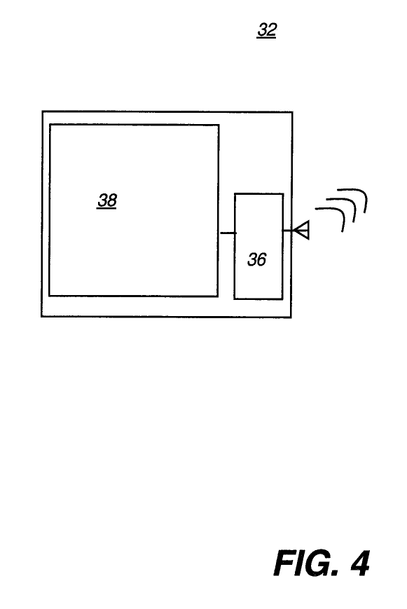

The schematic block diagram of FIG. 4 shows some of the internal components of an RFID tag 32 according to an embodiment of the present invention. RFID tag 32 has a communications circuit 36 that includes an antenna and the necessary components for signal transmission and reception. A memory 38, in signal communication with communications circuit 36, contains stored information related to the media type and other characteristics.

Radio Frequency Identification (RFID) transponders, also termed “tags”, are used in a number of identifying and tracking applications. Available from any of a number of manufacturers, RFID tags can be passive, active, or battery assisted passive. Passive RFID devices do not have on-board power, such as from a battery, while active RFID devices use an on-board power source to broadcast their signal. A battery assisted passive (BAP) has a small battery on board that is activated when in the presence of a RFID reader. Systems employing RFID tags typically comprise a read/write element, or RF transceiver, that acts as the interface between the RF ID tag and a computer system of some type that uses and/or provides the stored data. The RF ID tag itself is typically embodied as a transponder, having an integral antenna, adapted to send and receive electromagnetic fields in cooperation with the transceiver, where the electromagnetic field itself contains information to be conveyed to and from a memory on the RF ID tag.

As described with reference to FIG. 4, the RFID transponder, RFID tag 32, has an antenna and miniaturized communication circuit 36 for receiving and transmitting a signal with a transceiver and read-write memory 38 for storing and, alternately, for processing information. RFID tags 32 offer the advantage of small size, enabling these devices to be unobtrusively attached or hidden within an item. Unlike optical or mechanical equivalents, RFID tags allow communication regardless of orientation relative to a transceiver, although signal strength and communication distance can vary depending on the type of RFID device used.

A variable amount of information can be recorded in memory 38. Table 1 lists data fields in memory 38 for print media according to an exemplary embodiment of the present invention and indicates which fields may be updated as the corresponding media is used. The fields given are representative only; alternate fields may also be provided and read/write capability can be varied from that listed.

TABLE 1
RFID Transponder Stored Data

| Field | Description |
|---|---|
| Transponder ID # | Unique number assigned to the RFID tag at |
| | manufacture. RO |
| Cartridge ID # | Unique number assigned to media cartridge |
| | during manufacture. RO |
| Media type | Film, paper. RO |
| Transponder | Encoding indicating position of RFID tag on media |
| position | package (where two or more tags used for orien- |
| | tation detection). RO |
| Manufacturing | Lot number, line number, manufacturing date. RO |
| data | |
| Media expiration | Date. RO |
| Media size | Dimensions, A-sizes, etc. RO |
| Substrate | Smoothness, thickness, surface gloss, opacity, |
| information | etc. RO |
| Media tone | Tone information RO |
| Media shade | Shading or color characteristics of the media. |
| | Color gamut information. RO |
| Reproduction | Data on media response to marking engine, ink |
| characteristics | types, ink absorption. RO |
| Amount remaining | Number of sheets or length of media remaining. RW |
| Print count | Number of sheets or length of media that have |
| | been used from this package. RW |
| Date last used | Date information. RW |
| Printing | Printer ID for each printer that has used |
| system ID | media. RW |
| Image information | Listing of images printed using this media |
| | package. RW |
| Operator | Operator notes and recommendations or |
| annotation | procedures. RW |

RO—Read-Only data assigned at manufacture.
RW—Rewritable data, updated during use.

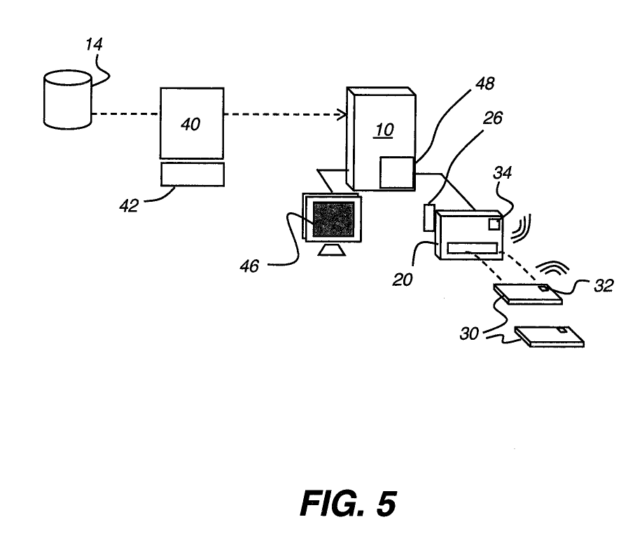

The schematic diagram of FIG. 5 shows a printer configuration for generating medical images according to an embodiment of the present invention. Image data 40 and associated metadata 42 are accessed from a database 14, such as a DICOM system, or, alternately, from a medical imaging device or system. A software application 10 running on a computer, workstation, host processor, networked processor, or other type of logic processing apparatus obtain image data 40 and associated metadata 42 and process the data for submission to printer 20. Printer 20 has one or more ink cartridges 26 and accepts the print medium, such as in roll or sheet form, from media package 30. Printer 20 has transceiver 34 for communication with the transponder that is coupled to the media, RFID tag 32. An optional display 46 enables application 10 to prompt the user for needed information or response in order to process the image data and metadata and provide printed image output.

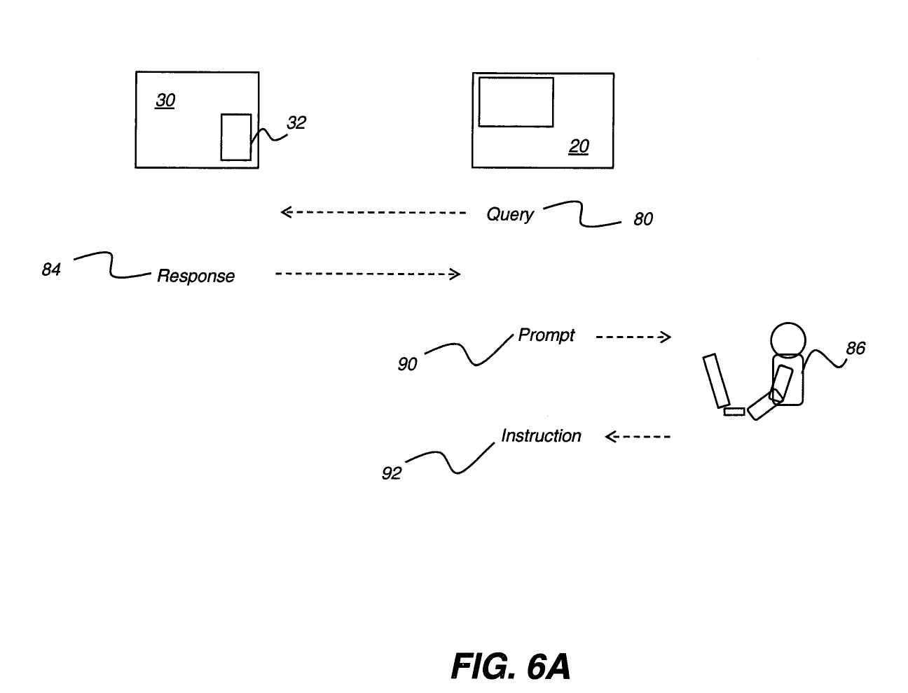

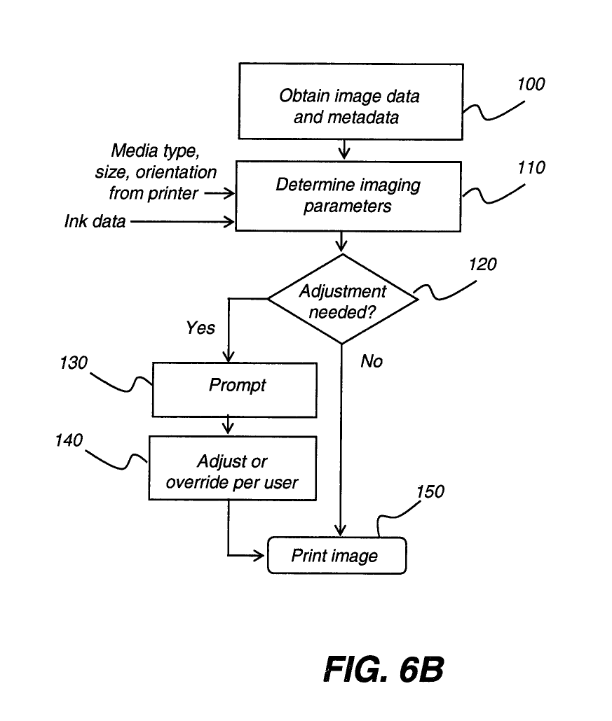

The logic flow diagram of FIG. 6A shows a sequence of signals sent between the transceiver and transponder, and printer and an operator 86, and actions taken by printer logic relating to printing a medical image, according to an embodiment of the present invention. To obtain information from RFID tag 32, transponder 34 sends a wireless query signal 80. This signal may be sent upon sensing a transition related to media loading or may be sent periodically. RFID tag 32 transmits a wireless response signal 84 that is indicative of at least the media orientation and media type and may include any of the other data listed in the Table given previously or other useful information related to printing. Application 10 then obtains this information and uses it to control print driver 48 for generating the image data in proper format for printing. Printer 20 may provide a prompt 90 to operator 86 to indicate a discrepancy between information stored with the image and the media type, orientation, or other characteristic. An operator instruction 92 then tells the printer how to proceed when there is a mismatch of media size, orientation, type, or other characteristic.

The logic flow diagram of FIG. 6B shows a sequence of steps used for providing an output print when using a printing configuration and application such as that shown in FIG. 5. In a data acquisition step 100, the medical image and its metadata are obtained from a DICOM system or from some other image source. Included with the image metadata, implicitly or explicitly, is information that indicates the dimensions and orientation of the image. In an image parameters computation step 110, the application obtains information from the printer, including the type, size, and orientation of the media currently loaded or installed in the printer and other useful information obtained from the one or more RFID tags 32 that are coupled to the media. Optionally, the application may also obtain information about the inks to be used, which may include ink type, color characteristics, binding characteristics, opacity, and other parameters that may be useful for computing the imaging parameters that are to be used for printing.

Based on the information obtained from the image and from the printer itself, the application then executes an adjustment determination step 120 that determines whether or not an adjustment or override may be needed relative to the loaded media. There can be a number of cases for which adjustment may be appropriate, but optional for the user of the printer. For example, metadata associated with the image data may indicate that the image has portrait orientation whereas the installed media is landscape. As another example, image scaling or tiling options may be available in some applications when image dimensions exceed media dimensions. As yet another example, it may be standard practice to print certain types of images onto specific types of media or using a particular ink type. Radiographic images, for example, are most often printed onto film for backlit display; installation of paper or other opaque medium may be sensed as a condition that requires adjustment. An ink type that is currently installed may not be optimal for the media type or for the range of colors or densities that are preferred for a specific image type.

Still referring to FIG. 6B, where no adjustment is needed, the image can be printed in a print step 150. It should be noted that print step 150 includes processing that relates to information obtained from RFID tag 32, such as the data listed in the Table given previously. For example, information about the media type, such as surface smoothness, color, opacity, and ink absorption characteristics, can be used to condition the print data that is provided from print driver 48. Print step 150 may also use image quality-related information provided with the image metadata 42, such as color characteristics, for example.

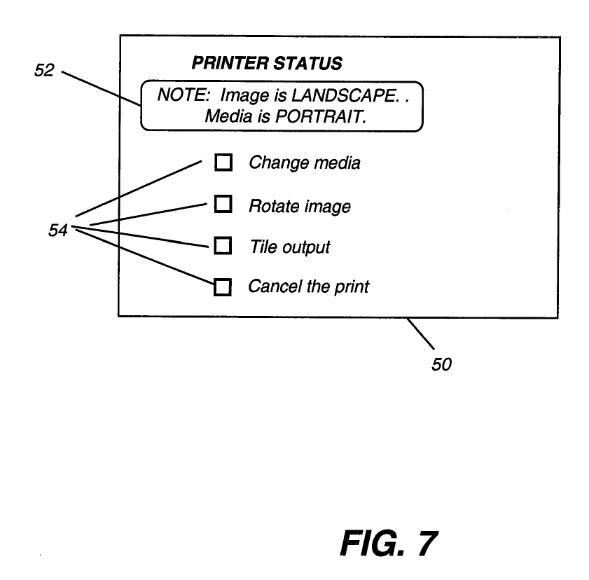

In the sequence of FIG. 6B, if some need for adjustment related to the loaded media is detected, an operator prompt step 130 executes, in which the operator is prompted to make the needed adjustment, to specify an override and use the existing media configuration, or to cancel the print job. Operator prompts can appear on a control panel of the printer or on optional display 46 (FIG. 5). The plan view of FIG. 7 shows an example display window 50 with a status message 52 and operator response selections 54. In the example shown, the operator can provide an instruction that indicates a media change, an instruction to rotate the image, an instruction for image tiling, printing multiple sheets in tiled form where the image size exceeds the media dimensions, an option to continue with possible loss of image data, or an instruction to cancel the print. Examples of some of these options are shown as selections 54 in FIG. 7. A subsequent adjustment step 140 then senses when the adjustment has been made, such as when media package 30 has been changed for the printer, for example. After the adjustment is made, print step 150 can execute to provide the final printed output. The operator prompt can be a recommendation, such as indicating a preferred media type for an image or a preferred ink type for the image or for the loaded media.

Where an operator instruction may not be recommended for providing the output characteristics that are generally preferred, such as using a media for which the image is not optimized, for example, an appropriate disclaimer message is displayed. A status message of this type may indicate a preferred course of action or provide additional information or data values that describe the deficiency in the image presentation that may result.

It can be appreciated that a number of other benefits and operating features are available by using RFID tags 32 coupled to the media package 30. As shown in FIG. 5, for example, different media packages 30 may be nearby, within communication distance to transceiver 34 and available for use with printer 20. Software on printer 20 may poll successive media packages 30 that are nearby to determine which is the best media for the image that is to be printed. A message may indicate to the user that a suitable or recommended medium is nearby but is not currently installed in the printer. A message may also indicate an expiration date, or, where there are multiple media packages, may recommend use of a media package having an earlier expiration date or having fewer remaining sheets of media. In this way, information from the RFID tag can be used to help manage media use, particularly where a printing apparatus serves multiple departments in a medical facility.

Embodiments of the present invention provide tracking capabilities that can help to identify which media package was used to generate a particular print. This can be useful for auditing the imaging process, assigning costs to print activities, identifying the cause or causes of different image quality characteristics between prints of the same anatomy, and other purposes.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for printing a medical image, the method comprising:
transmitting, from a transceiver that is associated with a printer, a wireless query signal;
receiving a wireless response signal from a transponder that is coupled to a print medium, the transponder having a memory, wherein the response signal is indicative of at least a media orientation and type available for printing, obtained from the memory;
obtaining image data and image orientation information associated with the image data;
providing a prompt signal that indicates a discrepancy between the media orientation and the image orientation associated with the image data; and
responding to an operator instruction to continue printing.

2. The method of claim 1 further comprising storing, in the memory, a record relating to the image and to the media orientation used for printing.

3. The method of claim 1 further comprising storing a print count in the memory.

4. The method of claim 1 wherein the response signal is further indicative of manufacturing information.

5. The method of claim 1 wherein the response signal is further indicative of at least one of media size, color, opacity, and smoothness.

6. The method of claim 1 further comprising displaying an operator prompt that recommends a different media type.

7. The method of claim 1 wherein obtaining the image data comprises obtaining data from a medical image database system.

8. The method of claim 1 wherein obtaining the image data comprises obtaining data from an imaging apparatus.

9. The method of claim 1 wherein the transceiver is a first transceiver and the wireless query signal a first wireless query signal and further comprising transmitting from a second transceiver that is associated with the printer, a second wireless query signal.

10. The method of claim 1 further comprising transmitting information related to a completed print to the transponder and storing data in the memory according to the transmitted information.

11. The method of claim 10 wherein storing data in the memory further comprises storing operator annotation in the memory.

12. A method for printing a medical image, comprising:
obtaining medical image data and information related to the dimensions of the medical image;
determining at least a media orientation and size for sheet media installed in a printer;
prompting a user to resolve a discrepancy between medical image dimensions and media orientation and size; and
printing the medical image onto the sheet media.

13. The method of claim 12 wherein printing the medical image further comprises obtaining, from a wireless transmission, information related to one or more reproduction characteristics of the media.

14. The method of claim 12 wherein obtaining the image data comprises obtaining data from a medical image database system.

15. The method of claim 12 wherein obtaining the image data comprises obtaining data from an imaging apparatus.

16. A method for printing a medical image, the method comprising:
transmitting, from a transceiver that is associated with a printer, a wireless query signal;
receiving a wireless response signal from a plurality of transponders, wherein each transponder is coupled to a print medium, the transponder having a memory, wherein the response signal is indicative of at least a media orientation and type available for printing, obtained from the memory;
obtaining image data and image orientation information associated with the image data;
indicating selection of one of the print media according to the response signal from the selected one of the print media; and
printing on the selected print medium.

17. The method of claim 16 wherein obtaining the image data comprises obtaining data from a medical image database system.

18. The method of claim 16 wherein obtaining the image data comprises obtaining data from an imaging apparatus.

19. The method of claim 16 wherein indicating the selection of one of the print media comprises displaying a message.
